(19) United States
(12) Patent Application Publication
(10) Pub. No.: US 2020/0189653 A1
(43) Pub. Date: Jun. 18, 2020

(54) PARKING SUPPORT APPARATUS

(71) Applicant: AISIN SEIKI KABUSHIKI KAISHA, Kariya-shi, Aichi-ken (JP)

(72) Inventors: Hironori HIRATA, Anjo-shi, Aichi-ken (JP); Nozomu MAEDA, Kariya-shi, Aichi-ken (JP); Masahiro ISHIHARA, Nishio-shi, Aichi-ken (JP)

(73) Assignee: AISIN SEIKI KABUSHIKI KAISHA, Kariya-shi, Aichi-ken (JP)

(21) Appl. No.: 16/607,837

(22) PCT Filed: Mar. 1, 2018
(86) PCT No.: PCT/JP2018/007789

§ 371 Date: Oct. 24, 2019

(30) Foreign Application Priority Data
Apr. 27, 2017 (JP) 2017-088684

(51) Int. Cl. B62D 6/00

(52) U.S. Cl. CPC B62D 6/002; B60W 30/06

(57) ABSTRACT

A parking support apparatus according to an embodiment includes: a hardware processor being configured to: calculate, when turning-back is performed for a vehicle to enter a parking frame, a steering angle such that a position of a turning center of the vehicle is, along a first direction that is vertical to a going-in direction of the vehicle with respect to the parking frame, more away from the parking frame than an outer edge that is opposite to an advancing direction of the vehicle on a turning-back position of the vehicle is; acquire, based on the calculated steering angle and the turning-back position, a moving path of the vehicle; and provide stationary steering control, based on the acquired moving path, in which the vehicle is steered while being stopped, so as to allow the vehicle to move.

### TECHNICAL FIELD

The present invention relates to a parking support apparatus.

### BACKGROUND ART

Conventionally, in techniques to support parking of vehicles, a technique to provide stationary steering control has been known, in which steering wheels (handles) of vehicles are rotated with the vehicles being stopped when steering for parking is to be performed after the vehicles are stopped.

### CITATION LIST

### Patent Literature

Patent Document 1: Japanese Laid-open Patent Publication No. 2010-269707
Patent Document 2: Japanese Laid-open Patent Publication No. 2004-224212

### SUMMARY OF INVENTION

### Problem to be Solved by the Invention

However, when a vehicle is made to go forward or back by stationary steering control, a moving path of the vehicle can deviate in a certain direction as the vehicle turns. When there is an obstacle or the like in the deviated direction, in some cases it is difficult for conventional parking support apparatuses to provide parking support.

Therefore, a parking support apparatus has been desired that is capable of reducing the possibility of causing a vehicle to contact an obstacle or the like during stationary steering control.

### Means for Solving Problem

A parking support apparatus according to an embodiment of the present invention includes, for example: a steering angle calculation unit that calculates, when turning-back is performed for a vehicle to enter a parking frame, a steering angle such that a position of a turning center of the vehicle is, along a first direction that is vertical to a going-in direction of the vehicle with respect to the parking frame, more away from the parking frame than an outer edge that is opposite to an advancing direction of the vehicle on a turning-back position of the vehicle is; a path acquisition unit that acquires, based on the calculated steering angle and the turning-back position, a moving path of the vehicle; and a move control unit that provides stationary steering control, based on the acquired moving path, in which the vehicle is steered while being stopped, so as to allow the vehicle to move. Consequently, in an example, in a case where stationary steering control is performed, it is possible to reduce the possibility of causing a vehicle to contact an obstacle or the like.

In the parking support apparatus, for example, the steering angle calculation unit calculates a plurality of the steering angles. The path acquisition unit judges whether the vehicle is capable of being parked in the parking frame from the turning-back position by stationary steering control at one try following any one of the calculated steering angles, determines that, when the vehicle is capable of being parked in the parking frame by the stationary steering control at one try, the moving path of the vehicle is a moving path that allows the vehicle to move to the parking frame based on a steering angle with which the vehicle is capable of moving to the parking frame and the turning-back position, and acquires, when the vehicle is not capable of being parked in the parking frame by the stationary steering control at one try, the moving path that allows the vehicle to move based on a largest steering angle among the calculated steering angles and the turning-back position. Consequently, in an example, it is possible to efficiently provide parking support by preferentially employing such a steering angle that allows parking in a target parking frame by stationary steering control at one try. In another example, it is possible to move a vehicle with a smaller space by steering with the largest steering angle among a plurality of calculated steering angles.

In the parking support apparatus, for example, the steering angle calculation unit calculates a plurality of the steering angles. The path acquisition unit judges whether the vehicle is capable of being parked in the parking frame from the turning-back position by stationary steering control at one try following any one of the calculated steering angles, determines that, when the vehicle is capable of being parked in the parking frame by the stationary steering control at one try, the moving path of the vehicle is a moving path that allows the vehicle to move to the parking frame based on a steering angle with which the vehicle is capable of moving to the parking frame and the turning-back position, and acquires, when the vehicle is not capable of being parked in the parking frame by the stationary steering control at one try, a moving path of the vehicle, based on the steering angle calculated with a retreat position until which the vehicle goes back from the turning-back position as a reference, and the retreat position. The steering angle calculation unit calculates, when the vehicle is not capable of being parked in the parking frame by the stationary steering control at one try, the steering angle such that the position of the turning center is, along the first direction, more away from the parking frame than an outer edge that is opposite to an advancing direction of the vehicle on the retreat position is. Consequently, in an example, in a case where a vehicle cannot be parked in a target parking frame directly from a turning-back position, the vehicle is capable of acquiring a moving path to the target parking frame in a more flexible manner.

The parking support apparatus further includes, for example, a mode selection unit that selects stationary steering mode in which the vehicle is steered while being stopped, when the vehicle is not capable of being parked in the parking frame in clothoid mode in which the vehicle is steered while being advanced. The steering angle calculation unit calculates the steering angle when the stationary steering mode is selected. Consequently, in an example, it is possible to further reduce a steering time and load on a steering system by preferentially selecting clothoid mode.

A parking support apparatus according to an embodiment of the present invention includes, for example: a steering angle calculation unit that calculates, when a vehicle goes out from a parking frame, a steering angle such that a position of a turning center of the vehicle is, along a first direction that is vertical to a going-out direction of the vehicle with respect to the parking frame, more away from the parking frame than an outer edge of the vehicle in an advancing direction side thereof on a turning end position at which the vehicle ends turning is, the turning end position, and a turning starting position at which the vehicle starts turning with the steering angle; a path acquisition unit that acquires, based on the calculated steering angle, the calculated turning start position, and the calculated turning end position, a moving path of the vehicle; and a move control unit that provides, based on the acquired moving path, stationary steering control in which the vehicle is steered while being stopped, so as to allow the vehicle to move. Consequently, in an example, in a case where the vehicle goes out from the parking frame, it is possible to further reduce the possibility of causing the vehicle to contact an obstacle or the like.

### BRIEF DESCRIPTION OF DRAWINGS

FIG. 1 is an exemplary perspective view illustrating a vehicle according to a first embodiment in a state having part of a compartment of the vehicle transparent;

FIG. 2 is a diagram illustrating an example of a hardware configuration of a vehicle control system including an electric control unit (ECU) according to the first embodiment;

FIG. 3 is a block diagram illustrating an example of a functional configuration of the ECU according to the first embodiment;

FIG. 4 is a diagram illustrating an example of a moving path of a vehicle during stationary steering control according to the first embodiment;

FIG. 5 is a flowchart illustrating an example of a procedure to determine a moving path according to the first embodiment;

FIG. 6 is a flowchart illustrating an example of the procedure to determine a moving path according to a second embodiment;

FIG. 7 is a block diagram illustrating an example of a functional configuration of an ECU according to a third embodiment;

FIG. 8 is a flowchart illustrating an example of a procedure to determine mode selection and a moving path according to the third embodiment;

FIG. 9 is a diagram illustrating an example of a moving path of a vehicle by stationary steering control for leaving a parking frame according to a fourth embodiment;

FIG. 10 is a flowchart illustrating an example of a procedure to determine a moving path for leaving a parking frame according to the fourth embodiment; and

FIG. 11 is a diagram explaining an example of the conventional technique.

### DESCRIPTION OF EMBODIMENTS

### First Embodiment

Exemplary embodiments of a parking support apparatus according to the present embodiment mounted on a vehicle 1 are described below.

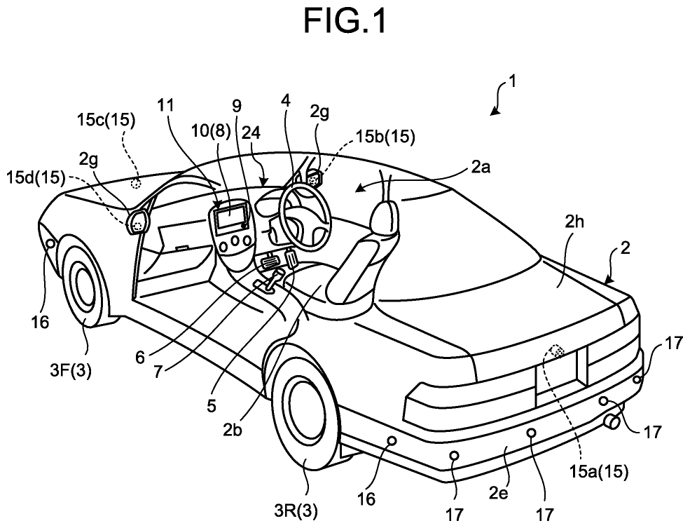

FIG. 1 is an exemplary perspective view illustrating a vehicle 1 according to a first embodiment in a state having part of a compartment 2a of the vehicle 1 transparent. In the first embodiment, the vehicle 1 having a vehicle control unit mounted thereon may be, for example, a vehicle using an internal combustion engine, which is not illustrated, as a driving source, specifically, an internal combustion engine vehicle, or a vehicle using a motor, which is not illustrated, as a driving source, specifically an electric vehicle or a fuel cell vehicle. Alternatively, the vehicle 1 may be a hybrid vehicle using both an internal combustion engine and a motor as driving sources, or may be a vehicle provided with other driving sources. Moreover, the vehicle 1 is capable of having various transmissions mounted thereon, and having various apparatuses, such as systems and components required for driving an internal combustion engine or a motor, mounted thereon.

As exemplified in FIG. 1, a body 2 constitutes the compartment 2a, which an occupant, which is not illustrated, is to get in. Inside the compartment 2a, a steering unit 4, an accelerating operation unit 5, a brake operation unit 6, a shifting operation unit 7, and the like are provided so as to face a seat 2b for a driver, which is the occupant.

The steering unit 4 is, for example, a steering wheel (handle) protruding from a dashboard 24. The accelerating operation unit 5 is, for example, an acceleration pedal disposed at a foot of a driver. The brake operation unit 6 is, for example, a brake pedal disposed at a foot of the driver. The shifting operation unit 7 is, for example, a shift lever protruding from a center console. It should be noted that the steering unit 4, the accelerating operation unit 5, the brake operation unit 6, and the shifting operation unit 7 are not limited thereto.

Inside the compartment 2a, a display device 8 that is a display output unit, and a voice output device 9 that is a voice output unit are provided. The display device 8 is, for example, a liquid crystal display (LCD), an organic electroluminescent display (OELD), or the like. The voice output device 9 is, for example, a speaker. The display device 8 is covered with an operation input unit 10, which is transparent, such as a touch panel, for example. The operation input unit 10 enables the occupant to visually recognize an image to be displayed on a screen of the display device 8. The occupant is able to execute operation input through operations such as touching and pushing the operation input unit 10 with his/her finger or the like or moving the finger or the like thereon at a position corresponding to an image displayed on the screen of the display device 8. The display device 8, the voice output device 9, the operation input unit 10, and the like are provided to a monitor device 11, which is positioned in a center part in a vehicle width direction, specifically, right and left directions of the dashboard 24, for example. The monitor device 11 may include an operation input unit, which is not illustrated, including switches, dials, joysticks, pushbuttons, and the like. The voice output device, which is not illustrated, may be provided to another position that is different from the monitor device 11, inside the compartment 2a, and voice may be output from the voice output device 9 on the monitor device 11 and another voice output device. It should be noted that the monitor device 11 can also serve as a navigation system or an audio system, for example. Moreover, inside the compartment 2a, a display device that is different from the display device 8 may be provided.

As exemplified in FIG. 1, the body 2 is provided with a plurality of imaging units 15, specifically four imaging units 15a to 15d, for example. The imaging units 15 are digital cameras each incorporating thereinto an image element such as a charge coupled device (CCD) and a CMOS image sensor (CIS), for example. The imaging units 15 are capable of outputting moving data at a certain frame rate. The imaging units 15 sequentially photograph (image) outside environments around the body 2, including road surfaces onto which the vehicle 1 can move and areas in which the vehicle 1 can be parked, and output the imaged data.

The imaging unit 15a is disposed on, for example, an edge 2e on a rear side of the body 2, and is provided to a wall section, which is a lower part of a door 2h of a rear trunk. The imaging unit 15b is disposed on, for example, an edge on the right side of the body 2. The imaging unit 15b is disposed on, for example, a door mirror 2g on the right side. The imaging unit 15c is disposed on, for example, the front side of the body 2, specifically an edge on the front side in the front and back directions of the vehicle. The imaging unit 15c is provided to, for example, a front bumper or the like. The imaging unit 15d is disposed on, for example, the left side of the body 2, that is, an edge on the left side of in the vehicle width direction. The imaging unit 15d is provided to, for example, a door mirror 2g that is a protruding unit on the left side. The number of the imaging units 15 is not limited to four, but may be five or more, or may be one.

As exemplified in FIG. 1, the vehicle 1 is a four-wheeled vehicle, for example, and has two front wheels 3F on the right and left thereof, and two rear wheels 3R on the right and left thereof. The four-wheeled vehicle can be configured in such a manner that these four wheels 3 are each steerable. Furthermore, mode, quantity, layout, and the like of equipment involved in driving of the wheels 3 of the vehicle 1 can be determined differently.

As exemplified in FIG. 1, the body 2 is provided with a plurality of distance measurement units 16 and 17. The distance measurement units 16 and 17 are sonars (sonar sensors or ultrasonic detectors) that emit ultrasonic waves and catch reflection waves of the ultrasonic waves, for example. The distance measurement unit 17 is used for detecting an object that is comparably a short distance away, for example. The distance measurement unit 16 is used for detecting an object that is comparably a longer distance away than an object to be detected by the distance measurement unit 17, for example. The distance measurement unit 17 is used for detecting an object in front of or in the rear of the vehicle 1, for example. The distance measurement unit 16 is also used for detecting an object at sides of the vehicle 1. The number and the position of each of the distance measurement units 16 and 17 provided for the body 2 are not limited to the examples indicated in FIG. 1.

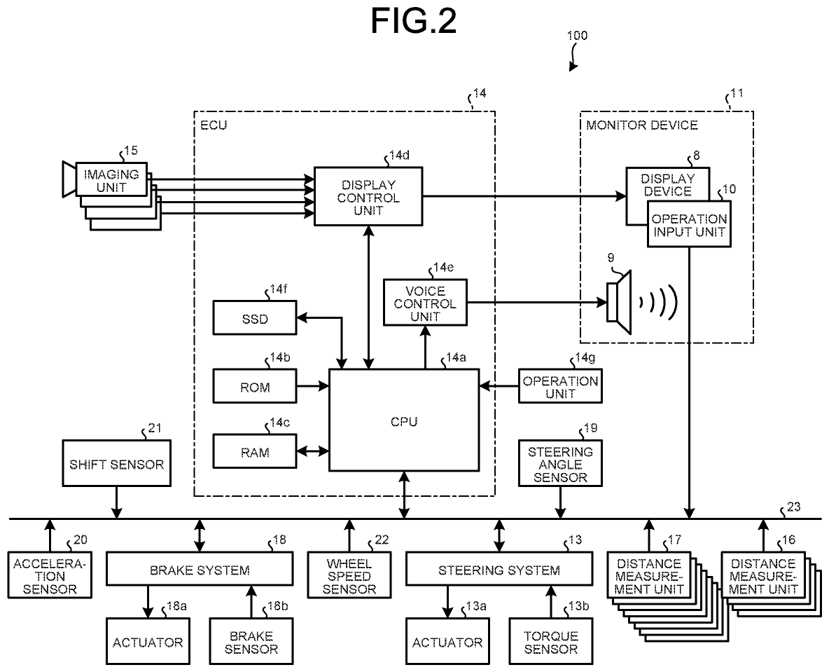

FIG. 2 is a diagram illustrating an example of a hardware configuration of a vehicle control system 100 including an electronic control unit (ECU) 14 according to the first embodiment. As illustrated in FIG. 2, in the vehicle control system 100, the ECU 14, the monitor device 11, a steering system 13, the distance measurement units 16 and 17, a brake system 18, a steering angle sensor 19 (angle sensor), an acceleration sensor 20, a shift sensor 21, a wheel speed sensor 22, and the like are electrically connected one another via a vehicle network 23 that is a telecommunication line.

The vehicle network 23 is configured as a controller area network (CAN), for example.

The ECU 14 transmits control signals via the vehicle network 23, so as to be able to control the steering system 13, the brake system 18, and the like. The ECU 14 is also capable of receiving, via the vehicle network 23, detection results from a torque sensor 13b, a brake sensor 18b, the steering angle sensor 19, the distance measurement units 16 and 17, the acceleration sensor 20, the shift sensor 21, the wheel speed sensor 22, and the like, and instruction signals (control signal, operation signal, input signal, and data) from the operation input unit 10 and the like. The ECU 14 is an example of the parking support apparatus of the first embodiment.

The ECU 14 includes a central processing unit (CPU) 14a, a read only memory (ROM) 14b, a random access memory (RAM) 14c, a display control unit 14d, a voice control unit 14e, a solid state drive (SSD) 14f, which is a flash memory, and the like, for example.

The CPU 14a reads out a computer program installed and stored in a nonvolatile storage device such as the ROM 14b, so as to be able to execute arithmetic processing following the computer program. The RAM 14c temporarily stores therein various types of data to be used for the arithmetic processing in the CPU 14a.

The display control unit 14d executes mainly, among the arithmetic processing in the ECU 14, image processing with image data received from the imaging units 15 and synthesis of image data to be displayed on the display device 8 and the like, for example. The display control unit 14d executes, for example, the arithmetic processing and image processing based on image data received from a plurality of the imaging units 15, so as to be able to generate images with wider viewing angles and generate virtual overhead images viewed from above the vehicle 1. It should be noted that an overhead image is also referred to as a plan image.

The voice control unit 14e executes mainly, among the arithmetic processing in the ECU 14, processing for voice data to be output from the voice output device 9.

The CPU 14a acquires operation signals to be output with operation input for an operation unit 14g. The operation unit 14g includes pushbuttons and switches, for example, and outputs operation signals.

The SSD 14f is a nonvolatile storage unit, which is rewritable, and is capable of storing therein data when the ECU 14 is powered off. It should be noted that the CPU 14a, the ROM 14b, the RAM 14c, and the like can be integrated in the same package. The ECU 14 may have a configuration in which other arithmetic logical processor such as a digital signal processor (DSP), a logical circuit, or the like is used instead of the CPU 14a. Instead of the SSD 14f, a hard disk drive (HDD) may be provided, and the SSD 14f or the HDD may be provided separately from the ECU 14.

The steering system 13 steers at least two wheels 3. The steering system 13 of the first embodiment, for example, steers the front wheels 3F of the vehicle 1. The steering system 13 includes an actuator 13a and a torque sensor 13b. The steering system 13 is electrically controlled with the ECU 14 and the like, so as to allow the actuator 13a to operate. The steering system 13 is, for example, an electric power steering system, a steer by wire (SBW) system, or the like. The steering system 13 enables the actuator 13a to add torque, specifically assist torque, to the steering unit 4 so as to compensate for steering force, or enables the actuator 13a to turn the wheels 3. In this case, the actuator 13a may turn one wheel 3 or a plurality of the wheels 3. Moreover, the torque sensor 13b detects torque that is, for example, given by a driver to the steering unit 4.

The brake system 18 is, for example, an anti-lock brake system (ABS) to prevent brake from being locked, an electronic stability control (ESC) to prevent sideslip of the vehicle 1 during cornering, an electric brake system (that executes brake assist) to enhance the braking force, brake by wire (BBW), or the like. The brake system 18 gives the braking force to the wheels 3, and the vehicle 1, via an actuator 18a. The brake system 18 detects locked brake, idling of each of the wheels 3, a symptom of sideslip, or the like from difference in rotation between the right and the left wheels 3, so as to execute various kinds of control. The brake sensor 18b is a sensor to detect the position of a movable unit of the brake operation unit 6, for example. The brake sensor 18b is capable of detecting the position of the brake pedal, which is the movable unit. The brake sensor 18b includes a displacement sensor. The brake sensor 18b transmits, for example, detection signals based on an operation input from the brake operation unit 6, for example, from the brake pedal to the ECU 14 via the brake system 18. Alternatively, the brake sensor 18b may have a configuration in which detection signals generated based on the operation input from the brake pedal are transmitted to the ECU 14 without intervention of the brake system 18.

The steering angle sensor 19 is a sensor to detect a steering amount (rotation angle) of the steering unit 4. In an example, the steering angle sensor 19 includes a hall element and the like. The ECU 14 acquires, from the steering angle sensor 19, a steering amount given by a driver in the steering unit 4, a steering amount of each of the wheels 3 during parking support by which automatic steering is performed, and other data, so as to execute various kinds of control. Furthermore, the ECU 14 is capable of suspending or stopping the automatic steering, for example when the brake operation unit 6 is operated during the automatic steering, by determining that the vehicle 1 is in a condition unsuitable for the automatic steering.

The acceleration sensor 20 is a sensor to detect the position of a movable unit of the acceleration operation unit 5, for example. The acceleration sensor 20 is capable of detecting the position of the acceleration pedal, which is the movable unit. The acceleration sensor 20 includes a displacement sensor.

The shift sensor 21 is a sensor to detect the position of a movable unit of the shifting operation unit 7, for example. The shift sensor 21 is capable of detecting the position of a lever, an arm, a button, or the like that is a movable unit. The shift sensor 21 may include a displacement sensor. The shift sensor 21 may be configured as a switch.

The wheel speed sensor 22 is a sensor to detect a rotation amount and the number of rotations per unit time of each of the wheels 3. The wheel speed sensor 22 transmits a sensed value, which is the number of pulses for the wheel speed with which the detected number of rotations is indicated, to the ECU 14. The wheel speed sensor 22 can include a hall element, for example. The ECU 14 calculates the move amount, the vehicle speed, and the like of the vehicle 1 based on the sensed value acquired from the wheel speed sensor 22, and executes various kinds of control. In some cases, the wheel speed sensor 22 is provided to the brake system 18. In these cases, the ECU 14 acquires detection results from the wheel speed sensor 22 via the brake system 18.

The above-described configurations, layouts, electrical connection forms, and the like of the sensors and the actuators are examples, and may be differently set (changed).

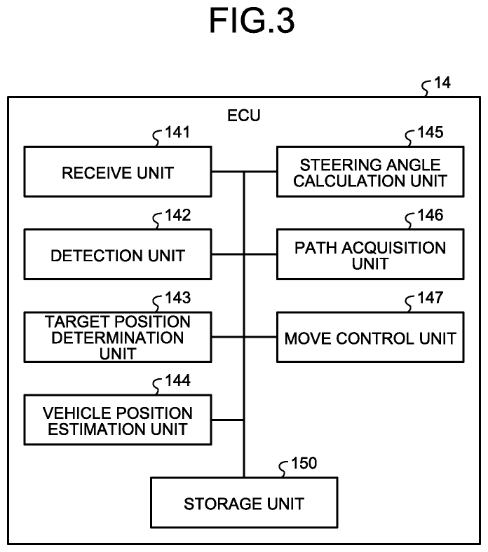

FIG. 3 is a block diagram illustrating an example of a functional configuration of the ECU 14 of the first embodiment. As illustrated in FIG. 3, the ECU 14 includes a receive unit 141, a detection unit 142, a target position determination unit 143, a vehicle position estimation unit 144, a steering angle calculation unit 145, a path acquisition unit 146, a move control unit 147, and a storage unit 150.

Components of the receive unit 141, the detection unit 142, the target position determination unit 143, the vehicle position estimation unit 144, the steering angle calculation unit 145, the path acquisition unit 146, and the move control unit 147, which are illustrated in FIG. 3, are each implemented when the CPU 14a executes the computer program stored in the ROM 14b. It should be noted that the above-described components may be implemented by a hardware circuit.

The storage unit 150 includes a storage device such as the SSD 14f, for example. The storage unit 150 stores therein data to be used for arithmetic operation in the ECU 14, data calculated in the arithmetic operation in the ECU 14, and other data.

The receive unit 141 receives an operation by a driver with operation signals acquired from the operation unit 14g. For example, the receive unit 141 receives an operation to start parking support. The receive unit 141 may receive an operation input by a driver not only from the operation unit 14g but also from the operation input unit 10 or the like. The receive unit 141 notifies the detection unit 142, the target position determination unit 143, the path acquisition unit 146, and the like of the received operation content.

The detection unit 142 detects other vehicle, an obstacle such as a pillar, a frame line of a parking lot, and the like from images around the body 2 that the imaging unit 15 has imaged. The detection unit 142 detects a parking frame, based on the detected obstacle, the detected frame line, the detected lot, and the like, in areas around the vehicle 1. For example, the detection unit 142 may detect the parking frame upon receiving from the receive unit 141 the notification that an operation to start parking support has been input by a driver.

The target position determination unit 143 determines a target parking frame, to which the vehicle 1 is moving, based on the detection results from the detection unit 142, and the like. The target position determination unit 143 may determine, based on an operation received by the receive unit 141, the operation having been selected by the driver, what parking frame is to be a target parking frame when the detection unit 142 detects a plurality of parking frames.

The vehicle position estimation unit 144 estimates, based on wheel speed information acquired from the wheel speed sensor 22, the position of the vehicle 1 and the orientation of the vehicle 1. Specifically, the vehicle position estimation unit 144 acquires, as a sensed value, the number of pulses for the wheel speed with which the number of rotations of the wheel 3 detected by the wheel speed sensor 22 is indicated. After that, the vehicle position estimation unit 144 calculates the move amount and the move direction of the vehicle 1 based on the number of rotations of each of the two, right and left, front wheels 3F and the two, right and left, rear wheels 3R, which are provided to the right and the left of the body 2.

Furthermore, the vehicle position estimation unit 144 detects that the vehicle 1 has been turned back during parking support. For example, the vehicle position estimation unit 144 judges that the vehicle 1 has been turned back when detecting that the vehicle 1 is stopped during parking support, and that the movable unit of the shifting operation unit 7 is set in reverse mode. In this case, the vehicle position estimation unit 144 adds the move amount and the move direction of the vehicle 1 after parking support starts until steering is detected to the position of the vehicle 1 at the time of starting the parking support, so as to estimate the turning-back position of the vehicle 1 and the orientation of the vehicle 1.

The turning-back position of the first embodiment may be matched with a position predetermined for performing turning-back with an initial path in parking support, or may be different from the predetermined position. For example, in the case where the vehicle 1 moves following the initial path, when a driver or the like stops the vehicle 1 before reaching a predetermined position, and sets the movable unit of the shifting operation unit 7 in reverse mode, the position at which the vehicle 1 is stopped is a turning-back position.

The initial path is a moving path of the vehicle 1 that the path acquisition unit 146, which will be described later, has acquired at the time of starting parking support.

The steering angle calculation unit 145 calculates a steering angle with which the moving path of the vehicle 1 will not deviate outward from a reference line when the vehicle 1 is turned by stationary steering control.

The reference line is positioned in a certain direction with respect to the vehicle 1. In an example, the reference line is a line that can include an obstacle thereon, but not limited thereto. The reference line will be described in detail later.

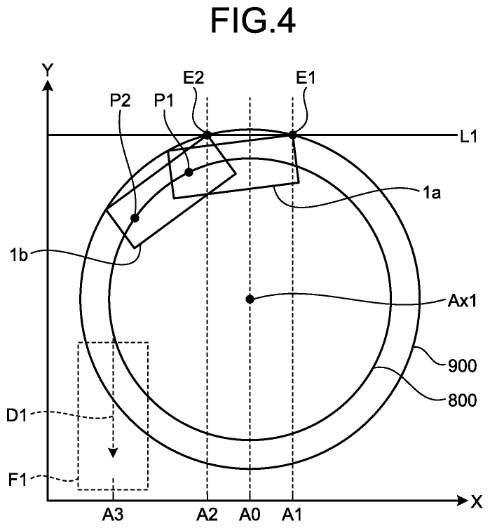

The steering angle with which the moving path of the vehicle 1 does not deviate outward from the reference line is specifically explained with reference to FIG. 4. FIG. 4 is a diagram illustrating an example of the moving path of the vehicle 1 by stationary steering control according to the first embodiment. In FIG. 4, different vehicles, a vehicle 1a and a vehicle 1b, are stopped to be steered. The vehicle 1a and the vehicle 1b are each simply referred to as the vehicle 1 when not being particularly distinguished from each other.

In the first embodiment, the position of the vehicle 1 is indicated by the center position of the rear axle connecting the two, right and left, rear wheels 3R of the vehicle 1. Specifically, a position P1 indicates the center position of the rear axle connecting the two, right and left, rear wheels 3R of the vehicle 1a. Moreover, a position P2 indicates the center position of the rear axle connecting the two, right and left, rear wheels 3R of the vehicle 1b. Alternatively, instead of the center of the rear axle of the vehicle 1, the position of the center of gravity of the vehicle 1 may be used for indicating the position of the vehicle 1.

The position P1 and the position P2 are positions at which the vehicle 1a and the vehicle 1b are to be steered, and thus are referred to as a turning-back position P1 and a turning-back position P2, respectively. The turning-back position P1 and the turning-back position P2 are each simply referred to as the turning-back position P when not being particularly distinguished from each other. The position of the turning-back position P is estimated with the above-described vehicle position estimation unit 144.

The parking support of the first embodiment presupposes that steering is performed after the vehicle 1 goes forward to a certain position from the vicinity of the target parking frame F1 indicated in FIG. 4, and then the vehicle 1 enters the target parking frame F1 by backing. The target parking frame F1 indicated in FIG. 4 is an example of a parking frame in the first embodiment.

The vehicle 1 enters the target parking frame F1 along a going-in direction D1. The going-in direction D1 is a direction parallel to the longitudinal direction of the target parking frame F1.

The X direction indicated in FIG. 4 is a direction vertical to the going-in direction D1. The X direction is an example of a first direction in the first embodiment. The X direction is a direction parallel to the lateral direction of the target parking frame F1. The X direction is also referred to as a direction along an access side (going-in and going-out side) of the target parking frame F1.

An Y direction indicated in FIG. 4 is a direction parallel to the going-in direction D1, and vertical to the X direction.

An outer edge E1 indicated in FIG. 4 is an outer edge opposite to the advancing direction of the vehicle 1a. An outer edge E2 is an outer edge opposite to the advancing direction of the vehicle 1b. The outer edge E1 and the outer edge E2 are each simply referred to as the outer edge E when not being particularly distinguished from each other.

The turning center Ax1 is the position of the turning center of the vehicle 1 that is turned by stationary steering control.

A trajectory 800 is a moving trajectory of the center of the rear axle of the vehicle 1 when the vehicle 1 turns by stationary steering control around the turning center Ax1. A trajectory 900 is a moving trajectory of the outer edge E when the vehicle 1 turns by stationary steering control around the turning center Ax1. When the vehicle 1 turns by stationary steering control, the trajectories 800 and 900 draw substantially regular circles as illustrated in FIG. 4. In FIG. 4, the steering angle of the vehicle 1a is equal to that of the vehicle 1b. In this case, the vehicles 1a and 1b that each turn by stationary steering control draw the same trajectories 800 and 900.

In an example of FIG. 4, with an intersection in the X direction and the Y direction defined as an origin, for example, the X coordinates and the Y coordinates are calculated for the turning-back position P, the outer edge E, the target parking frame F1, the turning center Ax1, and the like. A point on the X coordinate has a larger value as the point goes rightward along the X direction in FIG. 4, and a point on the Y coordinate has a larger value as the point goes upward along the Y direction in FIG. 4, for example. The calculation criteria on which the turning-back position P, the outer edge E, the target parking frame F1, the turning center Ax1, and the like are calculated are not limited thereto.

In FIG. 4, an obstacle line L1 is an example of a reference line to be virtually set by the steering angle calculation unit 145 to prevent the body 2 of the vehicle 1 from contacting an obstacle or the like. In the example of FIG. 4, the Y direction is an example of the certain direction.

Specifically, in the first embodiment, the obstacle line L1 is a straight line the Y coordinate of which is equal to that of the outer edge E on the turning-back position P. In other words, the obstacle line L1 in the first embodiment is a straight line passing through the outer edge E and being parallel to the X direction. In the example of FIG. 4, when the moving path of the vehicle 1 deviates in the Y direction side more than the obstacle line L1, it is estimated that the vehicle 1 can contact an obstacle or the like. Hereinafter, the moving path of the vehicle 1 deviating in the Y direction more than the obstacle line L1 is referred to as the moving path deviating outward from the obstacle line L1.

The steering angle calculation unit 145 estimates the position of the outer edge E based on the turning-back position P of the vehicle 1 and the orientation of the vehicle 1 that the vehicle position estimation unit 144 has estimated. Furthermore, the steering angle calculation unit 145 acquires the position of the target parking frame F1 that the target position determination unit 143 has determined. After that, the steering angle calculation unit 145 calculates an X direction and a Y direction based on the position of the target parking frame F1. The steering angle calculation unit 145 sets, based on the coordinate of the position of the outer edge E, the position of the obstacle line L1 that is a straight line the Y coordinate of which is equal to that of the outer edge E.

Generally, when the vehicle 1 is stopped at the turning-back position P, the vehicle 1 does not contact an obstacle or the like at the turning-back position P. Thus, by setting the obstacle line L1 with reference to the outer edge E on the turning-back position P, it is possible to prevent the vehicle 1 from contacting the obstacle or the like when calculating a steering angle. When a driver judges that the vehicle 1 would contact the obstacle or the like by following the moving path predetermined as an initial path by the parking support, in some cases the driver operates the brake operation unit 6 or the like to stop the vehicle 1 and performs steering for parking before the vehicle 1 reaches the predetermined turning-back position. In this case, the steering angle calculation unit 145 sets, based on the turning-back position P for the vehicle 1 that the vehicle position estimation unit 144 has estimated, the obstacle line L1, so as to be able to set the obstacle line L1 at a position where the vehicle 1 will not contact the obstacle or the like that the driver has judged that the vehicle 1 would be likely to contact.

A method for setting the obstacle line L1 is not limited thereto. For example, the obstacle line L1 may be, based on the position of the obstacle detected by the distance measurement units 16 and 17 or the like, set by the above-described detection unit 142 or the like. Alternatively, the obstacle line L1 may be, based on image data imaged in the imaging unit 15, set by the detection unit 142 or the like.

In order to prevent the outer edge E of the vehicle 1 from contacting the obstacle or the like, the steering angle calculation unit 145 calculates a steering angle with which the moving path of the vehicle 1 does not deviate outward from the obstacle line L1.

As illustrated in FIG. 4, for example, when the vehicle 1a turns around the turning center Ax1 with a certain steering angle from the turning-back position P1, the outer edge E1 goes beyond the obstacle line L1. However, when the vehicle 1b turns around the turning center Ax1 with the same steering angle as the above from the turning-back position P2, the outer edge E2 does not go beyond the obstacle line L1.

In other words, the moving path of the vehicle 1a indicated in FIG. 4 deviates outward from the obstacle line L1 and the moving path of the vehicle 1b does not deviate outward from the obstacle line L1.

Positional relation in the X direction will be explained on the vehicle 1a, the vehicle 1b, the turning center Ax1, and the target parking frame F1.

Dashed lines A0 to A3 indicated in FIG. 4 are straight lines with which the positional relation is explained for the turning center Ax1, the outer edges E1 and E2, and the target parking frame F1. The dashed line A0 is a straight line the X coordinate of which is equal to that of the turning center Ax1. The dashed line A1 is a straight line the X coordinate of which is equal to that of the outer edge E1. The dashed line A2 is a straight line the X coordinate of which is equal to that of the outer edge E2. The dashed line A3 is a straight line the X coordinate of which is equal to that of the center position of the target parking frame F1 in the lateral direction.

As illustrated in FIG. 4, difference between the X coordinate of the outer edge E1 of the vehicle 1a (dashed line A1) and the X coordinate of the center position of the target parking frame F1 in the lateral direction (dashed line A3) is greater than difference between the X coordinate of the turning center Ax1 (dashed line A0) and the X coordinate of the center position of the target parking frame F1 in the lateral direction (dashed line A3). Moreover, difference between the X coordinate of the outer edge E1 of the vehicle 1b (dashed line A2) and the X coordinate of the center position of the target parking frame F1 in the lateral direction (dashed line A3) is smaller than difference between the X coordinate of the turning center Ax1 (dashed line A0) and the X coordinate of the center position of the target parking frame F1 in the lateral direction (dashed line A3).

As indicated by the position on the X coordinate, when the moving path of the vehicle 1b does not deviate outward from the obstacle line L1, the outer edge E2 of the vehicle 1b is, along the X direction, closer to the target parking frame F1 side than the turning center Ax1 is.

In other words, when the moving path of the vehicle 1b does not deviate outward from the obstacle line L1, the steering angle of the vehicle 1b is such that the position of the turning center Ax1 of the vehicle 1b is, along the X direction, more away from the target parking frame F1 than the outer edge E2 that is opposite to the advancing direction of the vehicle 1b on the turning-back position P2 of the vehicle 1b is.

In contrast, as illustrated with the position on the X coordinate, the outer edge E1 of the vehicle 1a is, along the X direction, more away from the target parking frame F1 than the turning center Ax1 is. Thus, when the vehicle 1a turns around the turning center Ax1 from the turning-back position P1, the trajectory 900 of the outer edge E1 passes an area outside the obstacle line L1 in the Y direction. In this case, the moving path of the vehicle 1a deviates outward from the obstacle line L1.

In order to prevent the moving path of the vehicle 1a from deviating outward from the obstacle line L1, the steering angle calculation unit 145 sets a turning center for the vehicle 1a such that the turning center is at a position that is, along the X direction, more away from the target parking frame F1 than the outer edge E1, which is opposite to the advancing direction of the vehicle 1 on the turning-back position P1 of the vehicle 1a, is (in other words, a position the X coordinate of which is greater than that of the outer edge E1 (dashed line A1) in the X direction).

As described above, when the position that is more away from the target parking frame F1 than the outer edge E1 is set to the turning center of the vehicle 1a, a large turning radius occurs. This large turning radius can prevent the vehicle 1a from moving to the target parking frame F1. In this case, the path acquisition unit 146, which is later described, acquires such a moving path that allows the vehicle 1a to move assuming that the vicinity of the target parking frame F1 for the vehicle 1 is a target position. Consequently, restarting the parking support at the position that is the vicinity of the target parking frame F1 enables the vehicle 1 to move to the target parking frame F1.

The steering angle calculation unit 145 calculates a plurality of steering angles with which the moving path of the vehicle 1 does not deviate outward from the obstacle line L1. For example, the steering angle calculation unit 145 may calculate a plurality of steering angles with which the moving path does not deviate outward from the obstacle line L1 at each certain angle. Alternatively, the steering angle calculation unit 145 may calculate a plurality of steering angles by calculating a range of values of steering angles with which the moving path does not deviate outward from the obstacle line L1.

Referring back to FIG. 3, the path acquisition unit 146 acquires the moving path of the vehicle 1 based on the steering angle that the steering angle calculation unit 145 has calculated, with which the moving path does not deviate outward from the obstacle line L1, and the turning-back position P that the vehicle position estimation unit 144 has estimated.

Acquiring a moving path is generating a moving path by selecting circumferences and combining the circumferences. Selecting circumferences includes selecting one circumference out of a plurality of candidate circumferences. Selecting a circumference includes determining a circumference with any desired optional method.

For example, the storage unit 150 may store therein a plurality of circumferences in advance, and the path acquisition unit 146 may select one or more circumferences from the circumferences stored in the storage unit 150 to combine the selected circumferences. The path acquisition unit 146 may generate, in the acquisition of a moving path, a moving path by combining circumferences and straight lines. For example, the path acquisition unit 146 may generate, in the acquisition of a moving path, a moving path by combining circumferences determined based on the steering angles that the steering angle calculation unit 145 has calculated and straight lines.

Specifically, the path acquisition unit 146 judges whether the vehicle 1 is capable of being parked in the target parking frame F1 from the turning-back position P by stationary steering control at one try following the steering angle that the steering angle calculation unit 145 has calculated.

The path acquisition unit 146 determines that, when the vehicle 1 is capable of being parked in the target parking frame F1 from the turning-back position P by stationary steering control at one try, the moving path of the vehicle 1 is a moving path that allows the vehicle 1 to move to the target parking frame F1 based on the steering angle with which the vehicle 1 is capable of moving to the target parking frame F1 and the turning-back position P. The path acquisition unit 146 provides this determination to each of the steering angles that the steering angle calculation unit 145 has calculated.

When the vehicle 1 is not capable of being parked, with all the steering angles being used that the steering angle calculation unit 145 has calculated, in the target parking frame F1 from the turning-back position P by stationary steering control at one try, the path acquisition unit 146 acquires a moving path that allows the vehicle 1 to move based on the largest steering angle among the calculated steering angles and the turning-back position P. In this case, the path acquisition unit 146 acquires a moving path that allows the vehicle 1 to move assuming that the vicinity of the target parking frame F1 is a target position as described above. The target position is an example and is not limited thereto.

When the vehicle 1 turns with the largest steering angle with which the moving path does not deviate outward from the obstacle line L1, the vehicle 1 cannot directly enter the target parking frame F1, but it is possible to prevent the vehicle 1 from contacting an obstacle or the like and maintain the moving path of the vehicle 1 within a smaller space. Furthermore, moving the vehicle 1 to the vicinity of the access side of the target parking frame F1 enables the vehicle 1 to be parked more easily with the following steering in the target parking frame F1 from the turning-back position P.

The path acquisition unit 146 acquires a moving path that allows the vehicle 1 to move to the target parking frame F1 from the present position with the parking support started. In the first embodiment, the moving path of the vehicle 1 to be calculated by the path acquisition unit 146 is referred to as an initial path. For example, the path acquisition unit 146 calculates an initial path when being notified by the receive unit 141 that the driver has operated to start the parking support. The path acquisition unit 146 acquires a moving path, when the steering angle calculation unit 145 has calculated a steering angle, based on the steering angle and the turning-back position P, and replaces the initial path for the moving path.

Referring back to FIG. 3, the move control unit 147 executes steering control based on the moving path that the path acquisition unit 146 has calculated to allow the vehicle 1 to move. Specifically, the move control unit 147 controls the actuator 13a of the steering system 13 to provide stationary steering control. By the stationary steering control, the vehicle 1 is steered while being stopped, in accordance with the steering angle that the steering angle calculation unit 145 has calculated. At that time, the steering unit 4 may rotate following the steering provided by the move control unit 147. The move control unit 147 terminates the stationary steering control at a certain position so that the vehicle 1 will move along the moving path and allows the vehicle to move directly to the parking frame. The vehicle 1 is accelerated or decelerated (braked) as the driver operates the accelerating operation unit 5 or the brake operation unit 6. The move control unit 147 may instruct the driver of operations with the accelerating operation unit 5 or the brake operation unit 6 through guide displayed on the monitor device 11 or the like.

The parking support of the first embodiment exemplifies a case where the move control unit 147 executes automatic steering and a driver executes other operations as an example, but is not limited thereto. For example, the parking support of the first embodiment may employ a configuration in which the move control unit 147 executes automatic control on not only steering but also operations with the accelerating operation unit 5. The parking support of the first embodiment may also employ a configuration in which the move control unit 147 executes automatic control also on operations with the shifting operation unit 7.

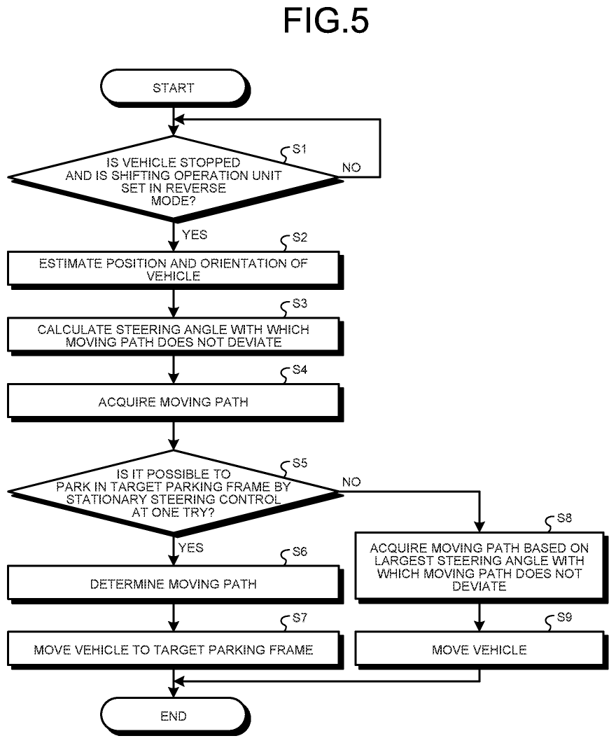

Next, the following describes steps to determine a moving path in the first embodiment configured as described above. FIG. 5 is a flowchart illustrating an example of the procedure to determine a moving path according to the first embodiment. The steps in this flowchart are started, for example, while parking support with the ECU 14 is being executed.

The vehicle position estimation unit 144 judges whether the vehicle 1 is stopped during the parking support and the movable unit of the shifting operation unit 7 is set in reverse mode (S1). If the vehicle 1 is not stopped during the parking support or when the vehicle 1 is stopped during the parking support but the movable unit of the shifting operation unit 7 is not set in reverse mode (No at S1), the vehicle position estimation unit 144 repeats Step S1.

The vehicle position estimation unit 144 estimates, when detecting that the vehicle 1 is stopped during the parking support and the movable unit of the shifting operation unit 7 is set in reverse mode (Yes at S1), the position of the vehicle 1 and the orientation of the vehicle 1 (S2). The position of the vehicle 1 at that time is the turning-back position P of the vehicle 1.

After that, the steering angle calculation unit 145 calculates a steering angle with which a moving path does not deviate outward from the obstacle line L1 (S3). Specifically, the steering angle calculation unit 145 calculates a plurality of steering angles such that the position of the turning center Ax1 of the vehicle 1 is, along the X direction, more away from the target parking frame F1 than the outer edge E, which is opposite to the advancing direction of the vehicle 1 on the turning-back position P of the vehicle 1, is.

After that, the path acquisition unit 146 acquires a moving path based on the steering angles that the steering angle calculation unit 145 has calculated and the turning-back position P that the vehicle position estimation unit 144 has estimated (S4).

After that, the path acquisition unit 146 judges, for each of the steering angles that the steering angle calculation unit 145 has calculated, whether the vehicle 1 is capable of being parked in the target parking frame F1 from the turning-back position P by stationary steering control at one try following the steering angle that the steering angle calculation unit 145 has calculated (S5).

When the vehicle 1 is capable of being parked in the target parking frame F1 from the turning-back position P by stationary steering control at one try with any one of the steering angles (Yes at S5), the path acquisition unit 146 determines that the moving path of the vehicle 1 is a moving path based on the steering angle and the turning-back position P (S6).

After that, the move control unit 147 allows the vehicle 1 to move to the target parking frame F1 based on the moving path determined as the moving path of the vehicle 1, out of the moving paths that the path acquisition unit 146 has calculated (S7).

If the vehicle 1 is not capable of being parked in the target parking frame F1 by stationary steering control at one try with all the steering angles being used (No at S5), the path acquisition unit 146 acquires a moving path based on the largest steering angle with which the moving path does not deviate outward from the obstacle line L1 and the turning-back position P (S8). The path acquisition unit 146 acquires, for example, a moving path that allows the vehicle 1 to move to the vicinity of the access side of the target parking frame F1 with the largest steering angle with which the moving path does not deviate outward from the obstacle line L1.

Then, the move control unit 147 allows the vehicle 1 to move to the vicinity of the access side of target parking frame F1 based on the moving path that the path acquisition unit 146 has calculated (S9).

Now the step to determine a moving path in the first embodiment completes. After Step S9, when another steering is performed for the vehicle 1 at a position to which the vehicle 1 has moved, the steps in this flowchart may be started again.

The first embodiment has a configuration in which first the steering angle calculation unit 145 calculates a plurality of steering angles, and then the path acquisition unit 146 calculates a moving path to each of the steering angles, but the flow of the steps is not limited thereto.

For example, the steering angle calculation unit 145 may calculate steering angles one by one from the smallest steering angle among steering angles with which the moving path does not deviate outward from the obstacle line L1. In this case, the path acquisition unit 146 may calculate a path, when one steering angle is calculated, to the one steering angle, so as to judge whether parking to the target parking frame F1 can be provided by stationary steering control at one try. With this configuration, calculation of the steering angle and the moving path terminates when the path acquisition unit 146 judges that the vehicle 1 is capable of being parked in the target parking frame F1 from the turning-back position P by stationary steering control at one try. Furthermore, the calculation of the steering angle and the moving path terminates also when the largest steering angle is reached, with which the moving path does not deviate outward from the obstacle line L1, without a steering angle with which the vehicle 1 is capable of moving to the target parking frame F1 from the turning-back position P by stationary steering control at one try.

With conventional parking support apparatuses, a moving path including a position at which steering is to be performed has been determined before a vehicle would approach a target parking frame. Therefore, when an obstacle or the like exists near a position at which steering is to be performed for a vehicle and the vehicle is turned by stationary steering control, the moving path of the vehicle is likely to deviate outward from the obstacle line L1, so as to contact the obstacle or the like.

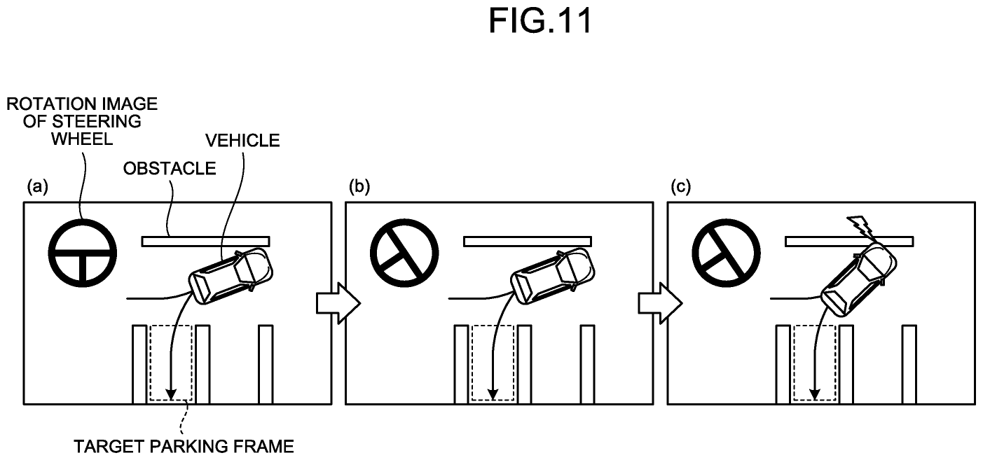

FIG. 11 is a diagram illustrating an example of the conventional technique. As illustrated in FIG. 11(a), for example, an obstacle exists near a position at which a vehicle starts backing to a target parking frame. In this case, as illustrated in FIG. 11(b), for example, a steering wheel of the vehicle is rotated with the vehicle being stopped, so as to start backing of the vehicle by stationary steering control. In this case, when the vehicle turns along a moving path that simply allows the vehicle to be parked in the target parking frame, as illustrated in FIG. 11(c), the vehicle is likely to contact the obstacle positioned outside a turning trajectory. With the conventional technique, when a driver stops the vehicle to avoid contacting an obstacle or the like or when the ECU or the like controls to stop the vehicle upon detection of an obstacle with a sonar or the like, in some cases it is difficult to restart parking support at the position where the vehicle is stopped.

In contrast, in the ECU 14 of the first embodiment, the steering angle calculation unit 145 calculates a steering angle with which the moving path of the vehicle 1 does not deviate outward from the obstacle line L1, thereby allowing the vehicle 1 to enter the target parking frame F1 without contacting an obstacle even when the obstacle exists near the moving path as illustrated in FIG. 11. Thus, the ECU 14 of the first embodiment is capable of reducing the possibility of causing the vehicle 1 to contact the obstacle or the like during stationary steering control. Furthermore, in the ECU 14 of the first embodiment, the steering angle calculation unit 145 calculates a steering angle with which the moving path of the vehicle 1 does not deviate outward from the obstacle line L1, it is possible to prevent the vehicle 1 from contacting the obstacle or the like with parking support being continued even when the vehicle 1 is stopped at an unplanned position so as to avoid contact with the obstacle or the like and steering is performed thereat.

As described above, in the ECU 14 of the first embodiment, the steering angle calculation unit 145 calculates, when steering is performed for the vehicle 1 to enter the target parking frame F1, a steering angle such that the position of the turning center Ax1 of the vehicle 1 is, along the X direction, more away from the target parking frame F1 than the outer edge E, which is opposite to the advancing direction of the vehicle 1 on the turning-back position P of the vehicle 1, is. Moreover, the path acquisition unit 146 acquires, based on the calculated steering angle and the turning-back position P, the moving path of the vehicle 1. After that, the move control unit 147 provides stationary steering control, based on the acquired moving path, in which the vehicle 1 is steered while being stopped, so as to allow the vehicle 1 to move. Consequently, with the ECU 14 of the first embodiment, it is possible to further reduce the possibility of causing the vehicle 1 to contact the obstacle or the like during the stationary steering control.

Moreover, in the ECU 14 of the first embodiment, the steering angle calculation unit 145 calculates a plurality of steering angles, and the path acquisition unit 146 judges whether the vehicle 1 is capable of being parked in the target parking frame F1 from the turning-back position P by stationary steering control at one try following any one of the calculated steering angles. The path acquisition unit 146 determines that, when the vehicle 1 is capable of being parked in the target parking frame F1 by the stationary steering control at one try, the moving path of the vehicle 1 is a moving path that allows the vehicle 1 to move to the target parking frame F1 based on the steering angle with which the vehicle 1 is capable of moving to the target parking frame F1 and the turning-back position P. Consequently, with the ECU 14 of the first embodiment, it is possible to efficiently provide parking support by preferentially employing such a steering angle that allows parking in the target parking frame F1 by stationary steering control at one try.

In the ECU 14 of the first embodiment, when the vehicle 1 is not capable of being parked in the target parking frame F1 by the stationary steering control at one try, the path acquisition unit 146 acquires a moving path that allows the vehicle 1 to move based on the largest steering angle among the calculated steering angles and the turning-back position P. Therefore, with the ECU 14 of the first embodiment, it is possible to prevent the vehicle 1 from contacting the obstacle or the like with parking support being continued even when it is difficult for the vehicle 1 to directly enter the target parking frame F1 from the turning-back position P. Furthermore, with the ECU 14 of the first embodiment, it is possible to move the vehicle 1 with a smaller space when the vehicle 1 is steered with the largest steering angle among the calculated steering angles.

It should be note that, in the first embodiment, while it is explained that the vehicle 1 enters the target parking frame F1 by backing, the vehicle 1 may enter the target parking frame F1 by going forward.

### Second Embodiment

With the ECU 14 of the first embodiment, when the vehicle 1 is not capable of being parked in the target parking frame F1 by stationary steering control at one try, the vehicle 1 is turned with the largest steering angle among a plurality of the calculated steering angles. In contrast, in the ECU 14 of a second embodiment, when a vehicle 1 is not capable of being parked in a target parking frame F1 by stationary steering control at one try, the vehicle 1 is made to go back, and a steering angle is further calculated.

The configuration of the vehicle 1 and the hardware configuration of a vehicle control system 100 including the ECU 14 of the second embodiment are the same as those in the first embodiment, which are illustrated in FIGS. 1 and 2.

Furthermore, similarly to the functional configuration of the first embodiment, which is illustrated in FIG. 3, the ECU 14 of the second embodiment includes a receive unit 141, a detection unit 142, a target position determination unit 143, a vehicle position estimation unit 144, a steering angle calculation unit 145, a path acquisition unit 146, a move control unit 147, and a storage unit 150.

The receive unit 141, the detection unit 142, the target position determination unit 143, the vehicle position estimation unit 144, the move control unit 147, and the storage unit 150, of the second embodiment, have the same functions as those in the first embodiment.

The path acquisition unit 146 of the second embodiment not only includes the same function as that in the first embodiment but also further calculates a parking path on which the vehicle 1 is made to go back when the vehicle 1 is not capable of being parked in the target parking frame F1 from the turning-back position P by stationary steering control at one try.

Specifically, the path acquisition unit 146 temporarily sets, when the vehicle 1 is not capable of being parked in the target parking frame F1 from the turning-back position P by stationary steering control at one try, a retreat position until which the vehicle 1 goes back from the turning-back position P.

A term “retreat” in the second embodiment refers to moving of the vehicle 1 in a direction opposite to the advancing direction along which the vehicle 1 moves so as to reach the turning-back position P. For example, in the second embodiment, when the vehicle 1 reaches the turning-back position P by going forward, backing of the vehicle 1 is referred to as retreat. Alternatively, when the vehicle 1 reaches the turning-back position P by backing, going forward of the vehicle 1 may be referred to as retreat.

Furthermore, the retreat position of the vehicle 1 need not be on a moving path on which the vehicle 1 has moved so as to reach the turning-back position P. Moreover, the vehicle 1 may also retreat on a path on which the vehicle 1 draws a clothoid curve by backing while steering, in addition to a case where the vehicle 1 goes forward and then goes back.

After temporarily setting the retreat position, the path acquisition unit 146 notifies the steering angle calculation unit 145 of the temporarily set retreat position. When the steering angle calculation unit 145, which is later described, calculates a plurality of steering angles with which a turning path of the vehicle 1 at the retreat position does not deviate outward from the obstacle line L1, the path acquisition unit 146 acquires a moving path based on the calculated steering angles.

After that, the path acquisition unit 146 judges, for each of the calculated steering angles, whether the vehicle 1 is capable of being parked in the target parking frame F1 from the retreat position by stationary steering control at one try following the steering angle that the steering angle calculation unit 145 has calculated. When the vehicle 1 is capable of being parked in the target parking frame F1 from the retreat position by stationary steering control at one try with any one of the steering angles, the path acquisition unit 146 determines that the moving path of the vehicle 1 is a moving path based on the steering angle with which the vehicle 1 is capable of moving to the target parking frame F1 and the retreat position.

When the vehicle 1 is not capable of being parked in the target parking frame F1 from the retreat position by stationary steering control at one try with all the steering angles being used, the path acquisition unit 146 newly temporarily sets another retreat position. For example, the path acquisition unit 146 may temporarily set a retreat position having a longer retreat distance from the turning-back position P.

The path acquisition unit 146 notifies the steering angle calculation unit 145 of the newly temporarily set retreat position, and repeats the above-described judgment, so as to acquire a retreat position and a steering angle with which the vehicle 1 is capable of being parked in the target parking frame F1.

The steering angle calculation unit 145 of the second embodiment not only includes the same function as that in the first embodiment but also calculates, based on the retreat position notified by the path acquisition unit 146 as described above, a plurality of steering angles with which the turning path of the vehicle 1 does not deviate outward from the obstacle line L1. The steering angle calculation unit 145 may calculate a plurality of steering angles with which the moving path does not deviate outward from the obstacle line L1 at each certain angle. Alternatively, the steering angle calculation unit 145 may calculate a plurality of steering angles by calculating a range of values of steering angles with which the moving path does not deviate outward from the obstacle line L1.

Specifically, the steering angle calculation unit 145 presumes that the vehicle 1 is turned by stationary steering control from the retreat position. After that, the steering angle calculation unit 145 calculates a steering angle such that the position of the turning center Ax1 of the vehicle 1 is, along the X direction, more away from the target parking frame F1 than the outer edge E, which is opposite to the advancing direction of the vehicle 1 on the retreat position of the vehicle 1, is.

In the second embodiment, while the steering angle calculation unit 145 calculates a plurality of steering angles with which a turning path of the vehicle 1 at the retreat position does not deviate outward from the obstacle line L1, the steering angle calculation unit 145 may only calculate one steering angle.

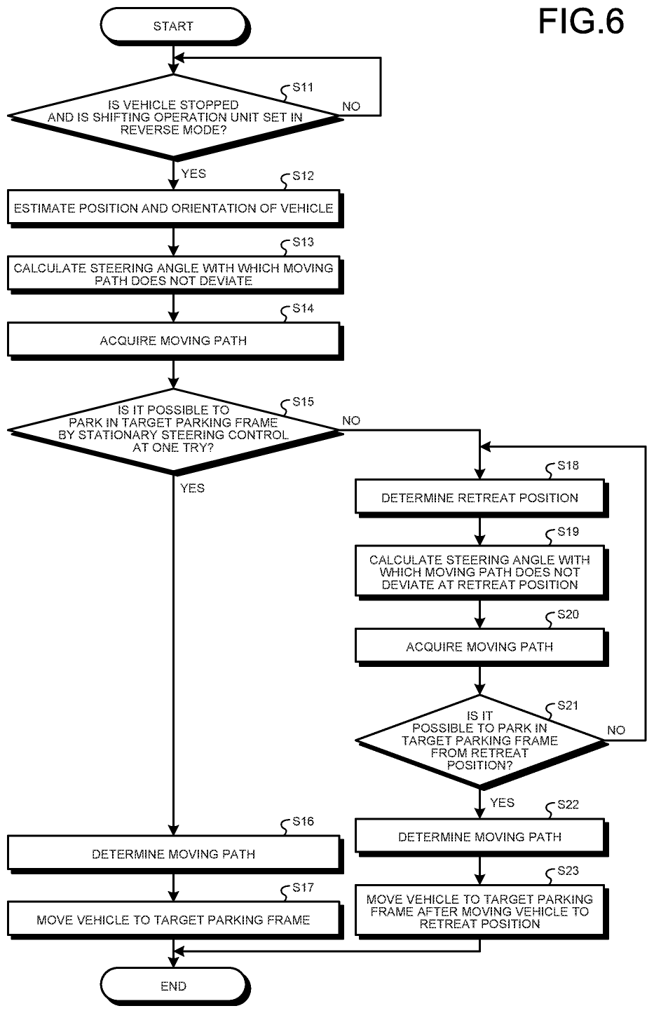

Next, the following describes steps to determine a moving path in the second embodiment configured as described above. FIG. 6 is a flowchart illustrating an example of the procedure to determine a moving path according to the second embodiment. The steps in this flowchart are started, for example, while parking support with the ECU 14 is being executed.

Steps indicated in FIG. 6 from S11 in which steering for the vehicle 1 is judged to S17 in which the vehicle 1 is moved to the target parking frame F1 are the same as Steps S1 to S7 indicated in FIG. 5.

If the vehicle 1 is not capable of being parked in the target parking frame F1 by stationary steering control at one try with all the steering angles being used (No at S15), the path acquisition unit 146 of the second embodiment temporarily sets a retreat position until which the vehicle 1 goes back (S18). The path acquisition unit 146 notifies the steering angle calculation unit 145 of the temporarily set retreat position.

The steering angle calculation unit 145 calculates a plurality of steering angles with which the turning path of the vehicle 1 does not deviate outward from the obstacle line L1, on the retreat position thereof (S19). The steering angle calculation unit 145 notifies the path acquisition unit 146 of the calculated steering angles.

The path acquisition unit 146 acquires a moving path based on the steering angles that the steering angle calculation unit 145 has calculated and the retreat position (S20).

The path acquisition unit 146 judges, for each of the steering angles that the steering angle calculation unit 145 has calculated, whether the vehicle 1 is capable of being parked in the target parking frame F1 from the retreat position by stationary steering control at one try following the steering angle that the steering angle calculation unit 145 has calculated (S21).

When the vehicle 1 is capable of being parked in the target parking frame F1 from the retreat position by stationary steering control at one try with any one of the steering angles (Yes at S21), the path acquisition unit 146 determines that the moving path of the vehicle 1 is a moving path based on the steering angle and the retreat position (S22).

After that, the move control unit 147 allows the vehicle 1 to move to the retreat position based on the moving path determined as the moving path of the vehicle 1, out of the moving paths that the path acquisition unit 146 has calculated, and then move to the target parking frame F1 (S23).

If the vehicle 1 is not capable of being parked in the target parking frame F1 from the retreat position by stationary steering control at one try with all the steering angles being used (No at S21), the path acquisition unit 146 newly temporarily sets another retreat position (S18). The path acquisition unit 146 and the steering angle calculation unit 145 repeat Steps S18 to S21, so as to calculate a retreat position and a steering angle that allow the vehicle 1 to be parked in the target parking frame F1 from the retreat position by stationary steering control at one try.

In the second embodiment, while the path acquisition unit 146 acquires the retreat position and the steering angle that allow the vehicle 1 to move to the target parking frame F1 from the retreat position by stationary steering control at one try, the retreat position and the steering ang1e are not limited thereto. For example, the path acquisition unit 146 may acquire a moving path that allows the vehicle 1 to move to the target parking frame F1 from the retreat position with some action including a plurality of times of steering.

As described above, in the ECU 14 of the second embodiment, when the vehicle 1 is not capable of being parked in the target parking frame F1 by stationary steering control at one try, the steering angle calculation unit 145 calculates a steering angle such that the position of the turning center Ax1 of the vehicle 1 is, along the X direction, more away from the target parking frame F1 than the outer edge E, which is opposite to the advancing direction of the vehicle 1 on the retreat position of the vehicle 1, is. Moreover, the path acquisition unit 146 acquires the moving path of the vehicle 1 based on a retreat position and the steering angle calculated with the retreat position as a reference. Consequently, with the ECU 14 of the second embodiment, it is possible not only to include the same effect as that in the first embodiment, but also to calculate a moving path that allows the vehicle 1 to be parked in the target parking frame F1 in a more flexible manner even when the vehicle 1 is not capable of directly parking in the target parking frame F1 from the turning-back position P. Furthermore, with the ECU 14 of the second embodiment, it is possible to prevent the vehicle 1 from contacting an obstacle or the like and allow the vehicle 1 to be parked in the target parking frame F1 in a more secure manner.

### Third Embodiment

In the first embodiment, the parking support presupposes that the vehicle 1 is turned by stationary steering control. In contrast, in a third embodiment, the ECU 14 has a plurality of modes of parking support.

The configuration of the vehicle 1 of the third embodiment and the hardware configuration of a vehicle control system 100 including the ECU 14 are the same as those in the first embodiment, which are illustrated in FIGS. 1 and 2.

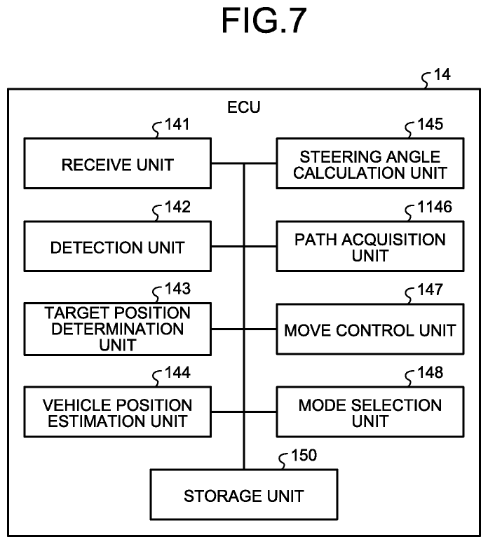

FIG. 7 is a block diagram illustrating an example of the functional configuration of the ECU 14 according to the third embodiment. As illustrated in FIG. 7, the ECU 14 of the third embodiment includes a receive unit 141, a detection unit 142, a target position determination unit 143, a vehicle position estimation unit 144, a steering angle calculation unit 145, a path acquisition unit 1146, a move control unit 147, a mode selection unit 148, and a storage unit 150.

Modules of the receive unit 141, the detection unit 142, the target position determination unit 143, the vehicle position estimation unit 144, the steering angle calculation unit 145, the path acquisition unit 1146, the move control unit 147, and the mode selection unit 148, which are illustrated in FIG. 7, are each implemented when the CPU 14a executes the computer program stored in the ROM 14b. It should be noted that those modules may be implemented by a hardware circuit.

The receive unit 141, the detection unit 142, the target position determination unit 143, the vehicle position estimation unit 144, the steering angle calculation unit 145, the move control unit 147, and the storage unit 150, of the third embodiment, have the same functions as those in the first embodiment.

The mode selection unit 148 selects, when steering is performed at a position where the vehicle 1 is yet to reach a steering planned position, either one of clothoid mode and stationary steering mode.

The clothoid mode is control mode in which the vehicle 1 is steered while being advanced. When the vehicle 1 is controlled in the clothoid mode, the vehicle 1 moves on a moving path to be drawn based on a clothoid curve.

The stationary steering mode is control mode to provide stationary steering control in which the vehicle 1 is steered while being stopped.

The steering planned position is a turning-back position of the vehicle 1 determined with an initial path.

Specifically, the mode selection unit 148 compares the turning-back position P of the vehicle 1 that the vehicle position estimation unit 144 has estimated with the steering planned position determined on the initial path. After that, the mode selection unit 148 judges whether the vehicle 1 has reached the steering planned position that coincides with the turning-back position P. When the vehicle 1 has reached the steering planned position, the mode selection unit 148 selects the clothoid mode.

When the vehicle 1 is yet to reach the steering planned position, the mode selection unit 148 judges whether the vehicle 1 is capable of being parked in the target parking frame F1 in the clothoid mode. When the vehicle 1 is capable of being parked in the target parking frame F1 in the clothoid mode, the mode selection unit 148 selects the clothoid mode. When the vehicle 1 is not capable of being parked in the target parking frame F1 in the clothoid mode, the mode selection unit 148 selects the stationary steering mode.

Whether the vehicle 1 is capable of being parked in the target parking frame F1 in the clothoid mode is judged based on the positional relation between the turning-back position P of the vehicle 1 and the target parking frame F1. For example, when the turning-back position P of the vehicle 1 is included in a positional range specific with respect to the target parking frame F1, the mode selection unit 148 may judge that the vehicle 1 is capable of being parked in the target parking frame F1 in the clothoid mode.

When the vehicle 1 is controlled in the stationary steering mode, the vehicle 1 starts moving after the steering therefor completes, and thus the vehicle 1 has a stop time longer than that in the clothoid mode. Moreover, generally, the stationary steering control provides higher load onto the steering system 13 compared with a case where the vehicle 1 moves on the moving path to be drawn based on the clothoid curve. In the third embodiment, the mode selection unit 148 preferentially employs the clothoid mode, thereby reducing a steering time and load onto the steering system 13.

When the vehicle 1 is controlled in the stationary steering mode, the vehicle 1 is capable of turning in a range narrower than that in the clothoid mode. Consequently, in a case where the vehicle 1 is not capable of being parked in the target parking frame F1 in the clothoid mode, when the mode selection unit 148 selects the stationary steering mode, the vehicle 1 is capable of moving more easily to the target parking frame F1 even in a parking lot or the like having a narrow road.

Which mode has been selected by the mode selection unit 148 may be stored in the storage unit 150, for example.

The path acquisition unit 1146 of the third embodiment not only includes the same function as that in the first embodiment but also acquires, when the clothoid mode has been selected, a moving path that allows the vehicle 1 to move from the turning-back position P to the target parking frame F1 along a path to be drawn based on a clothoid curve. Furthermore, the path acquisition unit 1146 acquires, when the stationary steering mode has been selected, a moving path that allows the vehicle 1 to move by stationary steering control similarly to the first embodiment.

The initial path to be calculated by the path acquisition unit 1146 of the third embodiment is a path that allows the vehicle 1 to move from the turning-back position P to the target parking frame F1 along the path to be drawn based on the clothoid curve.

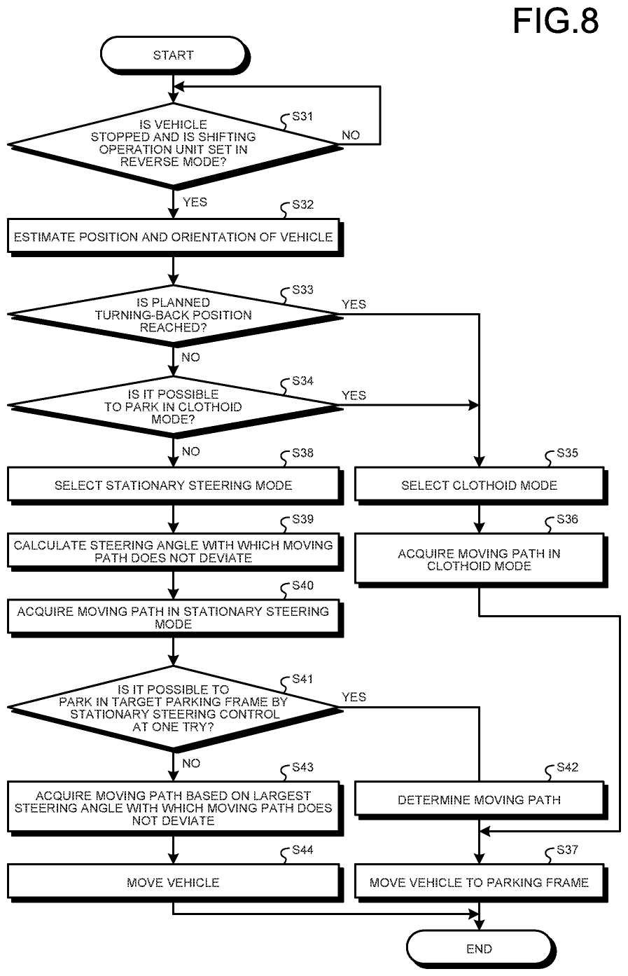

Next, the following describes steps to determine mode selection and a moving path in the third embodiment thus configured as described above. FIG. 8 is a flowchart illustrating an example of the procedure to determine mode selection and a moving path according to the third embodiment. The steps in this flowchart are started, for example, while parking support with the ECU 14 is being executed.

Steps indicated in FIG. 8 from S31 in which steering for the vehicle 1 is judged to S32 in which a position and an orientation of the vehicle 1 are estimated are the same as Steps S1 and S2 indicated in FIG. 5.

After the vehicle position estimation unit 144 estimates the position (turning-back position P) of the vehicle 1 and the orientation of the vehicle 1 in Step S32, the mode selection unit 148 compares the turning-back position P of the vehicle 1 that the vehicle position estimation unit 144 has estimated with the steering planned position determined on the initial path. After that, the mode selection unit 148 judges whether the vehicle 1 has reached the steering planned position that coincides with the turning-back position P (S33).

When the vehicle 1 has reached the steering planned position (Yes at S33), the mode selection unit 148 selects the clothoid mode (S35).

If the vehicle 1 is yet to reach the steering planned position (No at S33), the mode selection unit 148 judges whether the vehicle 1 is capable of being parked in the target parking frame F1 in the clothoid mode (S34).

When the vehicle 1 is capable of being parked in the target parking frame F1 in the clothoid mode (Yes at S34), the mode selection unit 148 selects the clothoid mode (S35).

The path acquisition unit 1146 acquires, when the clothoid mode has been selected by the mode selection unit 148, the moving path of the vehicle 1 in the clothoid mode (S36). Specifically, the path acquisition unit 1146 acquires a moving path that allows the vehicle 1 to move from the turning-back position P to the target parking frame F1 along a path to be drawn based on a clothoid curve.

The move control unit 147 allows the vehicle 1 to move to the target parking frame F1 based on the moving path that the path acquisition unit 1146 has calculated (S37).

If the vehicle 1 is not capable of being parked in the target parking frame F1 in the clothoid mode (No at S34), the mode selection unit 148 selects the stationary steering mode (S38).

Steps from S39 in which a steering angle is calculated with which a moving path does not deviate outward from the obstacle line L1 to S42 in which the moving path is determined are the same as Steps S3 to S6 indicated in FIG. 5.

After the path acquisition unit 1146 has determined the moving path in Step S42, similarly to Step S7 indicated in FIG. 5, the move control unit 147 allows the vehicle 1 to move to the target parking frame F1 (S37).

Steps from S43 in which a moving path is acquired based on the largest steering angle with which the moving path does not deviate outward from the obstacle line L1 to S44 in which the vehicle 1 is moved are the same as Steps S8 and S9 indicated in FIG. 5.

As described above, in the ECU 14 of the third embodiment, when the vehicle 1 is not capable of being parked in the target parking frame F1 in the clothoid mode, the mode selection unit 148 selects the stationary steering mode in which the vehicle 1 is steered while being stopped. Consequently, with the ECU 14 of the third embodiment, it is possible not only to include the same effect as that in the first embodiment, but also to preferentially select the clothoid mode, thereby reducing a steering time and load onto the steering system 13. Furthermore, with the ECU 14 of the third embodiment, it is possible to continue parking support in the stationary steering mode even when it is not possible to move the vehicle 1 to the target parking frame F1 in the clothoid mode.

In the third embodiment, while the mode selection unit 148 judges that the vehicle 1 is capable of being parked in the target parking frame F1 in the clothoid mode when the turning-back position P of the vehicle 1 is included in the positional range specific with respect to the target parking frame F1, judgment criteria is not limited thereto. For example, the path acquisition unit 1146 may perform simulation for moving the vehicle 1 in the clothoid mode. With this configuration employed, the mode selection unit 148 judges that the vehicle 1 is capable of being parked in the target parking frame F1 in the clothoid mode when the path acquisition unit 1146 has acquired a moving path that allows the vehicle 1 to be parked in the target parking frame F1 in the clothoid mode.

Furthermore, in the third embodiment, even when the vehicle 1 reaches the steering planned position, the path acquisition unit 1146 re-acquires a moving path, but the parking support may be continued with the initial path being maintained without reacquisition of a path.

Furthermore, in the third embodiment, only when the vehicle 1 is yet to reach the steering planned position, the mode selection unit 148 judges whether the vehicle 1 is capable of being parked in the clothoid mode, but the mode selection unit 148 may perform the above-described judgement each time the vehicle 1 is steered.

Alternatively, not only when the vehicle 1 is yet to reach the steering planned position, but also when the vehicle 1 goes beyond the steering planned position, the mode selection unit 148 may judge whether the vehicle 1 is capable of being parked in the clothoid mode.

It should be noted that, while the foregoing has explained that the third embodiment not only includes the same function as that of the ECU 14 of the first embodiment but also has another function newly added thereto, the third embodiment may also employ a configuration in which the third embodiment not only includes the same function as that of the ECU 14 of the second embodiment but also has another function newly added thereto.

### Fourth Embodiment

In the first embodiment, the parking support executed by the ECU 14 supports the vehicle 1 entering a parking frame. In contrast, the ECU 14 of the fourth embodiment executes parking support to support the vehicle 1 leaving a parking frame.

The configuration of the vehicle 1 of the fourth embodiment and the hardware configuration of a vehicle control system 100 including the ECU 14 are the same as those in the first embodiment, which are illustrated in FIGS. 1 and 2.

Similarly to the functional configuration of the first embodiment, which is illustrated in FIG. 3, the ECU 14 of the fourth embodiment includes a receive unit 141, a detection unit 142, a target position determination unit 143, a vehicle position estimation unit 144, a steering angle calculation unit 145, a path acquisition unit 146, a move control unit 147, and a storage unit 150.

The receive unit 141, the target position determination unit 143, the path acquisition unit 146, and the storage unit 150, of the fourth embodiment, have the same functions as those in the first embodiment.

The receive unit 141 of the fourth embodiment not only includes the same function as that in the first embodiment but also receives the fact that an operation has been made by a driver to start parking support for leaving a parking frame with operation signals acquired from the operation unit 14g. An operation to start the parking support for leaving a parking frame is referred to as “request for leaving a parking frame”. The receive unit 141 notifies the detection unit 142 of having received the request for leaving the parking frame.

The detection unit 142 of the fourth embodiment not only includes the same function as that in the first embodiment but also detects an obstacle or the like around the vehicle 1 based on images around the body 2 that the imaging unit 15 has imaged, and detection results of reflection waves from the distance measurement units 16 and 17. For example, the detection unit 142 calculates, when being notified by the receive unit 141 that the receive unit 141 has received the request for leaving the parking frame, a distance from the vehicle 1 to an obstacle or the like that exists near an exit of the parking frame. The detection unit 142 detects, based on the images around the body 2 that the imaging unit 15 has imaged, and the detection results of reflection waves from the distance measurement units 16 and 17, the width and the like of a road facing the access side of the parking frame.

Furthermore, the steering angle calculation unit 145 of the fourth embodiment calculates, when the vehicle 1 goes out from the parking frame, a steering angle with which the moving path of the vehicle 1 does not deviate outward from an obstacle line, a turning start position, and a turning end position. The turning start position is a position at which the vehicle 1 starts turning by stationary steering control. The turning end position is a position at which the vehicle 1 stops after going out from the parking frame and turning by the stationary steering control.

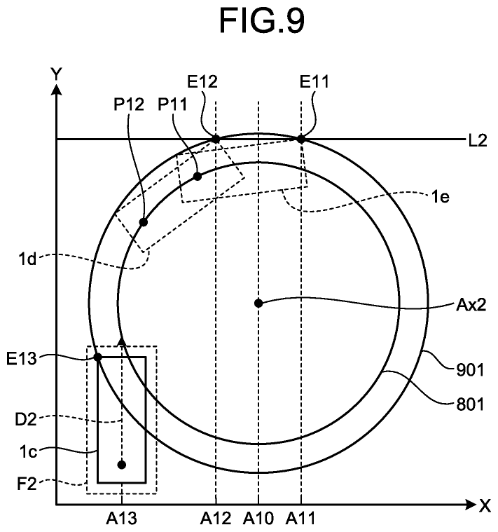

FIG. 9 is a diagram illustrating an example of the moving path of the vehicle 1 by stationary steering control for leaving a parking frame according to the fourth embodiment. A vehicle 1c indicated in FIG. 9 is parked in a parking frame F2. The vehicle 1c goes out from the parking frame F2 along a going-out direction D2. The going-out direction D2 is a direction parallel with the longitudinal direction of the parking frame F2. Moreover, the going-out direction D2 is a direction parallel with the going-in direction D1 of the vehicle 1 of the first embodiment described in FIG. 4.

In the fourth embodiment, the vehicle 1 may go out from the parking frame F2 by going forward or may go out from the parking frame F2 by backing.

An X direction indicated in FIG. 9 is a direction vertical to the going-out direction D2. The X direction is an example of a first direction in the fourth direction. A Y direction indicated in FIG. 9 is a direction parallel with the going-out direction D2, and a direction vertical to the X direction.

The vehicle 1c goes out from the parking frame F2 by going straight along the going-out direction D2, and then turns to change the direction of the vehicle 1c so as to face a direction along which the side of the vehicle 1c will face the parking frame F2, as indicated with a vehicle 1d or a vehicle 1e. Hereinafter, when the vehicles 1c to 1e are not particularly distinguished, the vehicles 1c to 1e are simply referred to as the vehicle 1.

An outer edge E13 of the vehicle 1c is an outer edge of the vehicle 1c in the advancing direction side thereof. An outer edge E12 of the vehicle 1d is an outer edge of the vehicle 1d in the advancing direction side thereof. An outer edge E11 of the vehicle 1e is an outer edge of the vehicle 1e in the advancing direction side thereof. Hereinafter, when the outer edges E11 to E13 are not particularly distinguished, the outer edges E11 to E13 are simply referred to as the outer edge E.

A position P11 is a center position of the rear axle connecting the two, right and left, rear wheels 3R of the vehicle 1e. A position P12 is a center position of a rear axle connecting the two, right and left, rear wheels 3R of the vehicle 1d. Moreover, the position P11 is a turning end position of the vehicle 1e. The position P12 is a turning end position of the vehicle 1d. Accordingly, when the positions P11 and P12 are not distinguished from each other, the positions P11 and P12 are also referred to as the turning end position P.

A turning center Ax2 is the position of a turning center of the vehicle 1 when the vehicle 1 turns by stationary steering control.

A trajectory 801 is a trajectory of moving of the center of the rear wheel axle of the vehicle 1 when the vehicle 1 turns by stationary steering control around the turning center Ax2. A trajectory 901 is a trajectory of moving of the outer edge E when the vehicle 1 turns by stationary steering control around the turning center Ax2. When the vehicle 1 turns by stationary steering control, the trajectories 801 and 901 substantially draw regular circles as illustrated in FIG. 9.

Furthermore, the turning start position is a position at which the vehicle 1 starts turning, after going straight in the going-out direction D2, so that the turning will draw the trajectories 801 and 901.

An obstacle line L2 indicated in FIG. 9 is a reference line to be virtually set by the steering angle calculation unit 145 so as to prevent the body 2 of the vehicle 1 from contacting an obstacle or the like. The obstacle line L2 in the fourth embodiment is set by the steering angle calculation unit 145, based on the width of a road facing the access side of the parking frame F2, the width being detected by the detection unit 142, a distance from the vehicle 1 to the obstacle, and the like, as an upper limit of a position until which the vehicle 1 is capable of advancing.

Furthermore, the obstacle line L2 may be positioned in parallel with the X direction at a position distant away from the parking frame F2 by a certain distance. Alternatively, the obstacle line L2 may be set, based on the position of an obstacle detected by the distance measurement units 16 and 17 or the like, by the above-described detection unit 142 or the like. Alternatively, the obstacle line L2 may be set, based on image data imaged by the imaging unit 15, by the detection unit 142 or the like.

As illustrated in FIG. 9, when the vehicle 1c goes out from the parking frame F2, turns along the trajectories 801 and 901, and then stops at the position of the vehicle 1e, the outer edge E11 goes beyond the obstacle line L2. In the fourth embodiment, the outer edge E11 going beyond the obstacle line L2 in this manner is referred to as the moving path of the vehicle 1 deviating outward from the obstacle line L2.

In contrast, when the vehicle 1c goes out from the parking frame F2, turns along the trajectories 801 and 901, and then stops at the position of the vehicle 1d, the outer edge E12 does not go beyond the obstacle line L2. In this case, it is recited that the moving path of the vehicle 1 does not deviate outward from the obstacle line L2.

The following explains a positional relation, in the X direction, among the vehicle 1d, the vehicle 1e, the turning center Ax2, and the parking frame F2.

The dashed lines A10 to A13 indicated in FIG. 9 are straight lines for describing the positional relation among the turning center Ax2, the outer edges E11 and E12, and the parking frame F2. The dashed line A10 is a straight line the X coordinate of which is equal to that of the turning center Ax2. The dashed line A11 is a straight line the X coordinate of which is equal to that of the outer edge E11. The dashed line A12 is a straight line the X coordinate of which is equal to that of the outer edge E12. The dashed line A13 is a straight line the X coordinate of which is equal to that of the center position of the parking frame F2 in the lateral direction.

As illustrated in FIG. 9, difference between the X coordinate of the outer edge E11 (dashed line A11) of the vehicle 1e and the X coordinate of the center position of the parking frame F2 in the lateral direction (dashed line A13) is greater than difference between the X coordinate of the turning center Ax2 (dashed line A10) and the X coordinate of the center position of the parking frame F2 in the lateral direction (dashed line A13). Moreover, difference between the X coordinate of the outer edge E12 of the vehicle 1d (dashed line A12) and the X coordinate of the center position of the parking frame F2 in the lateral direction (dashed line A13) is smaller than difference between the X coordinate of the turning center Ax2 (dashed line A10) and the X coordinate of the center position of the parking frame F2 in the lateral direction (dashed line A13).

As expressed with the position of the X coordinate, the outer edge E12 of the vehicle 1d is, along the X direction, closer to the target parking frame F2 side than the turning center Ax2 is.

The steering angle in the fourth embodiment, with which the moving path of the vehicle 1c that moves to the position of the vehicle 1d does not deviate outward from the obstacle line L2, is such a steering angle that the position of the turning center Ax2 is, along the X direction, more away from the parking frame F2 than the outer edge E12 of the vehicle 1d in the advancing side thereof at the turning end position P12 is.

Even with the same steering angle, a moving path can deviate outward from the obstacle line L2 depending on the turning start position of the vehicle 1 and the turning end position P. As described above, when the vehicle 1c moves to the position of the vehicle 1e even with the same steering angle as the steering angle in a case where the vehicle 1c moves to the position of the vehicle 1d, the moving path deviates outward from the obstacle line L2.

Then, the steering angle calculation unit 145 of the fourth embodiment calculates a steering angle with which the moving path of the vehicle 1 does not deviate outward from the obstacle line L2, and the turning start position and the turning end position P of the vehicle 1, one each corresponding to the steering angle. For example, the steering angle calculation unit 145 may calculate a steering angle, a turning start position, and a turning end position P, with which the moving path of the vehicle 1 is provided with the smallest space. Furthermore, the steering angle calculation unit 145 may calculate the largest steering angle among steering angles with which the moving path of the vehicle 1 does not deviate outward from the obstacle line L2, and a turning start position and a turning end position P, each corresponding to the largest steering angle.

The path acquisition unit 146 of the fourth embodiment not only includes the same function as that of the first embodiment but also acquires the moving path of the vehicle 1 based on the calculated steering angle, the calculated turning start position, and the calculated turning end position P. Specifically, the path acquisition unit 146 acquires such a moving path that the vehicle 1 goes out from the parking frame F2 along the going-out direction D2, turns by stationary steering control with the steering angle calculated from the calculated turning start position, and stops at the calculated turning end position P.

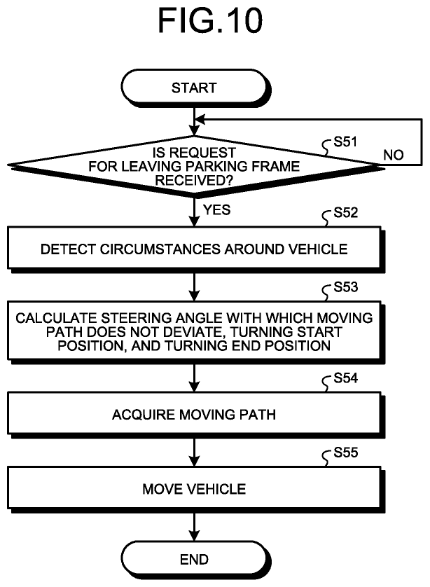

Next, the following describes steps to determine mode selection and a moving path for leaving a parking frame in the fourth embodiment thus configured as described above. FIG. 10 is a flowchart illustrating an example of the procedure to determine mode selection and a moving path for leaving a parking frame according to the fourth embodiment.

The receive unit 141 judges whether a request for leaving a parking frame from a driver is received (S51). If the request for leaving a parking frame from the driver is not received (No at S51), the receive unit 141 waits until the request for leaving a parking frame is received.

When the receive unit 141 has received the request for leaving a parking frame from the driver (Yes at S51), the receive unit 141 notifies the detection unit 142 of receiving the request for leaving a parking frame.

When the detection unit 142 is notified by the receive unit 141 that the receive unit 141 has received the request for leaving a parking frame, the detection unit 142 detects circumstances around the vehicle 1 (S52). Specifically, the detection unit 142 calculates a distance from the vehicle 1 to an obstacle or the like that exists near the exit of the parking frame F2. Moreover, the detection unit 142 detects, based on images around the body 2 that the imaging unit 15 has imaged and detection results of reflection waves from the distance measurement units 16 and 17, the width of the road facing the access side of the parking frame F2, and the like.

The steering angle calculation unit 145 sets the obstacle line L2 based on the detection results of the receive unit 141. After that, the steering angle calculation unit 145 calculates a steering angle with which the moving path does not deviate outward from the obstacle line L2, a turning start position, and a turning end position P (S53).

The path acquisition unit 146 acquires the moving path of the vehicle 1, based on the calculated turning angle, the calculated turning start position, and the calculated turning end position P (S54).

The move control unit 147 allows, based on the moving path that the path acquisition unit 146 has calculated, the vehicle 1 to move (S55).

As described above, in the ECU 14 of the fourth embodiment, the steering angle calculation unit 145 calculates such a steering angle that the position of the turning center Ax2 of the vehicle is, along the X direction, more away from the parking frame F2 than the outer edge E of the vehicle 1 in the advancing direction side thereof at the turning end position P is when the vehicle 1 goes out from the parking frame F2, a turning end position P, and a turning start position. Furthermore, the path acquisition unit 146 acquires, based on the calculated steering angle, the calculated turning start position, and the calculated turning end position P, the moving path of the vehicle 1. After that, the move control unit 147 provides stationary steering control, based on the acquired moving path, in which the vehicle 1 is steered while being stopped, so as to allow the vehicle 1 to move. Consequently, with the ECU 14 of the fourth embodiment, it is possible to reduce the possibility of causing the vehicle 1 to contact the obstacle or the like when the vehicle 1 goes out from the parking frame F2.

While the steering angle calculation unit 145 of the fourth embodiment calculates one steering angle with which the moving path of the vehicle 1 does not deviate outward from the obstacle line L2, the steering angle calculation unit 145 may calculate a plurality of the steering angles with which the moving path of the vehicle 1 does not deviate outward from the obstacle line L2 at each certain angle. For example, the steering angle calculation unit 145 may calculate a plurality of steering angles with which the moving path does not deviate outward from the obstacle line L2, at each certain angle. Alternatively, the steering angle calculation unit 145 may calculate a plurality of steering angles by calculating a range of values of steering angles with which the moving path does not deviate outward from the obstacle line L2.

Furthermore, the turning start position and the turning end position P may be calculated corresponding to each of the steering angles. Moreover, with a turning start position being fixed, the turning start position may correspond to a plurality of steering angles and a plurality of turning end positions P. Alternatively, with a turning end position P being fixed, the turning end position P may correspond to a plurality of steering angles and a plurality of turning start positions.

While functional units of the ECU 14 of the fourth embodiment not only include the same functions as those in the first embodiment, but also include a function for parking support for leaving a parking frame, the function of each functional units is not limited thereto. For example, the functional units of the ECU 14 may be parts that only provide support for leaving a parking frame without including the function for entering a parking frame.

While the foregoing has explained that the fourth embodiment includes not only the function of the ECU 14 of the first embodiment but also has another function newly added thereto, the fourth embodiment may employ such a configuration in which a function of the fourth embodiment is newly added to the function of the ECU 14 of each of the second and the third embodiments.

As in the foregoing, some embodiments of the present invention have been exemplified, however, the above-described embodiments and modifications are merely examples, and are not intended to limit the scope of the invention. The above-described embodiments and modifications can be implemented in various aspects, and various kinds of omission, replacement, combination, and change therefor can be made without departing from the scope of the invention. Moreover, the embodiments and the modifications can be implemented with part of the configurations and the shapes thereof replaced one another.

1. A parking support apparatus comprising:
a hardware processor being configured to:
calculate, when steering is performed for a vehicle to enter a parking frame, a steering angle such that a position of a turning center of the vehicle is, along a first direction that is vertical to a going-in direction of the vehicle with respect to the parking frame, more away from the parking frame than an outer edge that is opposite to an advancing direction of the vehicle on a turning-back position of the vehicle is;
acquire, based on the calculated steering angle and the turning-back position, a moving path of the vehicle; and
provide stationary steering control, based on the acquired moving path, in which the vehicle is steered while being stopped, so as to allow the vehicle to move.

2. The parking support apparatus according to claim 1, wherein
the hardware processor calculates a plurality of the steering angles, and
judges whether the vehicle is capable of being parked in the parking frame from the turning-back position by stationary steering control at one try following any one of the calculated steering angles, determines that, when the vehicle is capable of being parked in the parking frame by the stationary steering control at one try, the moving path of the vehicle is a moving path that allows the vehicle to move to the parking frame based on a steering angle with which the vehicle is capable of moving to the parking frame and the turning-back position, and acquires, when the vehicle is not capable of being parked in the parking frame by the stationary steering control at one try, the moving path that allows the vehicle to move based on a largest steering angle among the calculated steering angles and the turning-back position.

3. The parking support apparatus according to claim 1, wherein
the hardware processor calculates a plurality of the steering angles,
judges whether the vehicle is capable of being parked in the parking frame from the turning-back position by stationary steering control at one try following any one of the calculated steering angles, determines that, when the vehicle is capable of being parked in the parking frame by the stationary steering control at one try, the moving path of the vehicle is a moving path that allows the vehicle to move to the parking frame based on a steering angle with which the vehicle is capable of moving to the parking frame and the turning-back position, and acquires, when the vehicle is not capable of being parked in the parking frame by the stationary steering control at one try, a moving path of the vehicle, based on the steering angle calculated with a retreat position until which the vehicle goes back from the turning-back position as a reference, and the retreat position, and
calculates, when the vehicle is not capable of being parked in the parking frame by the stationary steering control at one try, the steering angle such that the position of the turning center is, along the first direction, more away from the parking frame than an outer edge that is opposite to an advancing direction of the vehicle on the retreat position is.

4. The parking support apparatus according to claim 1, wherein the hardware processor selects stationary steering mode in which the vehicle is steered while being stopped, when the vehicle is not capable of being parked in the parking frame in clothoid mode in which the vehicle is steered while being advanced, and
calculates the steering angle when the stationary steering mode is selected.

5. A parking support apparatus comprising:
a hardware processor being configured to: calculate, when a vehicle goes out from a parking frame, a steering angle such that a position of a turning center of the vehicle is, along a first direction that is vertical to a going-out direction of the vehicle with respect to the parking frame, more away from the parking frame than an outer edge of the vehicle in an advancing direction side thereof on a turning end position at which the vehicle ends turning is, the turning end position, and a turning starting position at which the vehicle starts turning with the steering angle;
acquire, based on the calculated steering angle, the calculated turning start position, and the calculated turning end position, a moving path of the vehicle; and
provide, based on the acquired moving path, stationary steering control in which the vehicle is steered while being stopped, so as to allow the vehicle to move.
